(19) United States
(12) Patent Application Publication
(10) Pub. No.: US 2007/0248738 A1
(43) Pub. Date: Oct. 25, 2007

(54) Food Products Comprising Long Chain Polyunsaturated Fatty Acids and Methods for Preparing the Same

(75) Inventors: Jesus Ruben Abril, Westminster, CO (US); Michelle Crandell, Longmont, CO (US)

Correspondence Address: SHERIDAN ROSS PC, 1560 BROADWAY, SUITE 1200, DENVER, CO, 80202, US

(73) Assignee: MARTEK BIOSCIENCES CORPORATION, Columbia, MD (US)

(21) Appl. No.: 11/773,340

(22) Filed: Jul. 3, 2007

Related U.S. Application Data
(63) Continuation of application No. 11/734,213, filed on Apr. 11, 2007.
(60) Provisional application No. 60/791,358, filed on Apr. 11, 2006.

(51) Int. Cl. A23D 9/00

(52) U.S. Cl. 426/601

(57) ABSTRACT

The present invention includes a food oil composition comprising a blend of a first oil comprising an LC PUFA and a second oil comprising substantially no LC PUFA. The first oil can preferably comprise an omega-3 LC PUFA, an omega-6 LC PUFA or mixtures thereof. The present invention also provides methods of food preparation, more particularly, methods for skillet-frying, deep-frying, methods for preparing edible lipid-containing food sauces, methods for preparing extruded food products, and methods for enhancing the LC PUFA content of a food product, particularly previously cooked food products, and food products prepared in accordance with such methods. Such compositions and methods are useful, for example, for increasing intake of LC PUFAs.

### CROSS-REFERENCE TO RELATED TO RELATED APPLICATION

This application is a continuation of U.S. application Ser. No. 11/734,213, filed Apr. 11, 2007, which claims the benefit of priority under 35 U.S.C. § 119(e) of U.S. Provisional Application Ser. No. 60/791,358, filed Apr. 11, 2006. The disclosure of each of these application is incorporated by reference herein in its entirety.

### FIELD OF THE INVENTION

The invention relates to food oil compositions, methods for food preparation, and food products comprising long chain polyunsaturated fatty acids, and particularly, omega-3 long chain polyunsaturated fatty acids, omega-6 long chain polyunsaturated fatty acids, and mixtures thereof.

### BACKGROUND

It is desirable to increase the dietary intake of the beneficial omega-3 polyunsaturated fatty acids (omega-3 PUFA), and omega-3 long chain polyunsaturated fatty acids (LC PUFA). Other beneficial nutrients are omega-6 long chain polyunsaturated fatty acids. As used herein, reference to a long chain polyunsaturated fatty acid or LC PUFA, refers to a polyunsaturated fatty acid having 20 or more carbons. Omega-3 PUFAs are recognized as important dietary compounds for preventing arteriosclerosis and coronary heart disease, for alleviating inflammatory conditions, cognitive impairment and dementia related diseases and for retarding the growth of tumor cells. One important class of omega-3 PUFAs is omega-3 LC PUFAs. Omega-6 LC-PUFAs serve not only as structural lipids in the human body, but also as precursors for a number of factors in inflammation such as prostaglandins, and leukotrienes.

Fatty acids are carboxylic acids and are classified based on the length and saturation characteristics of the carbon chain. Short chain fatty acids have 2 to about 6 carbons and are typically saturated. Medium chain fatty acids have from about 6 to about 18 carbons and may be saturated or unsaturated. Long chain fatty acids have from 20 to 24 or more carbons and may also be saturated or unsaturated. In longer chain fatty acids there may be one or more points of unsaturation, giving rise to the terms “monounsaturated” and “polyunsaturated,” respectively. Long chain PUFAs (LC PUFAs) are of particular interest in the present invention.

LC PUFAs are categorized according to the number and position of double bonds in the fatty acids according to a well understood nomenclature. There are two series or families of LC PUFAs, depending on the position of the double bond closest to the methyl end of the fatty acid: the ω-3 (or n-3 or omega-3) series contains a double bond at the third carbon, while the ω-6 (or n-6 or omega-6) series has no double bond until the sixth carbon. Thus, docosahexaenoic acid (“DHA”) has a chain length of 22 carbons with 6 double bonds beginning with the third carbon from the methyl end and is designated “22:6 n-3”. Another important LC PUFA is eicosapentaenoic acid (“EPA”) which is designated “20:5 n-3”.

De novo or “new” synthesis of the omega-3 and omega-6 fatty acids such as DHA and ARA does not occur in the human body; however, the body can convert shorter chain fatty acids to LC PUFAs such as DHA and ARA although at very low efficiency. Both omega-3 and omega-6 fatty acids must be part of the nutritional intake since the human body cannot insert double bonds closer to the omega end than the seventh carbon atom counting from that end of the molecule. Thus, all metabolic conversions occur without altering the omega end of the molecule that contains the omega-3 and omega-6 double bonds. Consequently, omega-3 and omega-6 acids are two separate families of essential fatty acids since they are not interconvertible in the human body.

Over the past twenty years, health experts have recommended diets lower in saturated fats and higher in polyunsaturated fats. While this advice has been followed by a number of consumers, the incidence of heart disease, cancer, diabetes and many other debilitating diseases has continued to increase steadily. Scientists agree that the type and source of polyunsaturated fats is as critical as the total quantity of fats. The most common polyunsaturated fats are derived from vegetable matter and are lacking in long chain fatty acids (most particularly omega-3 LC-PUFAs). In addition, the hydrogenation of polyunsaturated fats to create synthetic fats has contributed to the rise of certain health disorders and exacerbated the deficiency in some essential fatty acids. Indeed, many medical conditions have been identified as benefiting from an omega-3 supplementation. These include acne, allergies, Alzheimer's, arthritis, atherosclerosis, breast cysts, cancer, cystic fibrosis, diabetes, eczema, hypertension, hyperactivity, intestinal disorders, kidney dysfunction, leukemia, and multiple sclerosis. Of note, the World Health Organization has recommended that infant formulas be enriched with omega-3 and omega-6 fatty acids.

The polyunsaturates derived from meat contain significant amounts of omega-6 but little or no omega-3. While omega-6 and omega-3 fatty acids are both necessary for good health, they must be consumed in a balance of about 4:1. Today's Western diet has created a serious imbalance with current consumption on average of 20 times more omega-6 than omega-3. Concerned consumers have begun to look for health food supplements to restore the equilibrium. Principal sources of omega-3 are flaxseed oil and fish oils. The past decade has seen rapid growth in the production of flaxseed and fish oils. Both types of oil are considered good dietary sources of omega-3 polyunsaturated fats. Flaxseed oil contains no EPA, DHA, or DPA but rather contains linolenic acid—a building block that can be elongated by the body to build longer chain PUFAs. There is evidence, however, that the rate of metabolic conversion can be slow and unsteady, particularly among those with impaired health. Fish oils vary considerably in the type and level of fatty acid composition depending on the particular species and their diets. For example, fish raised by aquaculture tend to have a lower level of omega-3 fatty acids than fish from the wild. In light of the health benefits of such omega-3 and omega-6 LC-PUFAs, it would be desirable to supplement foods with such fatty acids.

Due to the scarcity of sources of omega-3 LC PUFAs, typical home-prepared and convenience foods are low in both omega-3 PUFAs and omega-3 LC PUFAs (chain length greater than 20), such as docosahexaneoic acid, docosapentaenoic acid, and eicosapentaenoic acid. In light of the health benefits of such omega-3 LC PUFAs (chain length greater than 20), it would be desirable to supplement foods with such fatty acids.

While foods and dietary supplements prepared with LC PUFAs may be healthier, they also have an increased vulnerability to rancidity. Rancidity in lipids, such as unsaturated fatty acids, is associated with oxidation off-flavor development. The oxidation off-flavor development involves food deterioration affecting flavor, aroma, and the nutritional value of the particular food. A primary source of oxidation off-flavor development in lipids, and consequently the products that contain them, is the chemical reaction of lipids with oxygen. The rate at which this oxidation reaction proceeds has generally been understood to be affected by factors such as temperature, degree of unsaturation of the lipids, oxygen level, ultraviolet light exposure, presence of trace amounts of pro-oxidant metals (such as iron, copper, or nickel), lipoxidase enzymes, and so forth.

The susceptibility and rate of oxidation of the unsaturated fatty acids can rise dramatically as a function of increasing degree of unsaturation in particular. In this regard, EPA and DHA contain five and six double bonds, respectively. This high level of unsaturation renders the omega-3 fatty acids readily oxidizable. The natural instability of such oils gives rise to unpleasant odor and unsavory flavor characteristics even after a relatively short period of storage time.

PUFAs may extracted from microbial sources for use in nutritional and/or pharmaceutical products. For example, DHA-rich microbial oil is manufactured from the dinoflagellate Crypthecodinium cohnii and ARA-rich oil is manufactured from the filamentous fungus Mortierella alpina, both for use as nutritional supplements and in food products such as infant formula. Similarly, DHA-rich microbial oil from Schizochytrium is manufactured for use as a nutritional supplement or food ingredient. Typically, the LC PUFAs are extracted from biomass and purified. The extracted and purified oils can be further processed to achieve specific formulations for use in food products (such as a dry powder or liquid emulsion).

In light of the desirability of supplementing foods with omega-3 LC PUFAs and/or omega-6 LC PUFAs, and in view of the shortcomings of the prior art in providing these foods, there is a need for methods for enriching foods with omega-3 LC PUFAs and/or omega-6 LC PUFAs and also for food oil compositions and food products comprising omega-3 LC PUFAs and/or omega-6 LC PUFAs. These and other needs are answered by the present invention.

### SUMMARY OF THE INVENTION

The present invention is directed toward food oil compositions and their uses in food products. The food oil compositions generally include a blend of a first oil having LC PUFAs and preferably, an omega-3 LC PUFA, an omega-6 LC PUFA or mixtures thereof and a second oil that includes substantially no LC PUFAs, and preferably, substantially no omega-3 LC PUFA and substantially no omega-6 LC-PUFA and that is liquid at room temperature.

In a first embodiment, the food oil composition includes a blend of a first oil comprising an LC PUFA, and preferably an omega-3 LC PUFA, an omega-6 LC PUFA or mixtures thereof and a second oil comprising substantially no LC PUFAs, and preferably, substantially no omega-3 LC PUFA, wherein the second oil is liquid at room temperature. In an alternate embodiment the food oil composition includes a blend of a first oil comprising an LC PUFA, and preferably an omega-3 LC PUFA, an omega-6 LC PUFA or mixtures thereof and a second oil comprising substantially no LC PUFAs, and substantially no omega-6 LC PUFA, wherein the second oil is liquid at room temperature. In these embodiments, the blend comprises between about 0.01% and about 5% of the LC PUFAs. In a further embodiment, the blend can comprise between about 0.08% and about 3% LC PUFAs or between about 0.1% and about 0.5% LC PUFAs. This first embodiment of the invention is particularly useful for preparing skillet-fried food products. Such products can include between about 5 mg and about 150 mg omega-3 LC PUFAs, omega-6 LC PUFAs or mixtures thereof per food product or serving. A further aspect of this embodiment is a method for food preparation of a food item capable of being skillet fried. This method includes placing the food item and an oil on to a skillet. The oil includes the first food oil composition embodiment described above. Heat is applied to the skillet sufficient to heat the food item, thereby frying the food. In an alternate embodiment, this food oil composition is useful for preparing deep-fried food products, such as tempura or fries, as well as methods for food preparation of a food item capable of being deep-fried. This method includes immersing the food item in an oil. The oil includes the first food oil composition embodiment described above. Heat is applied to the oil sufficient to heat the food item, thereby deep-frying the food.

A second food oil composition embodiment of the present invention includes a blend of a first oil comprising an LC PUFA and preferably, an omega-3 LC PUFA, an omega-6 LC PUFA or mixtures thereof and a second oil comprising substantially no LC PUFAs and preferably substantially no omega-3 LC PUFAs and substantially no omega-6 LC PUFAs, and wherein the second oil is liquid at room temperature. In this embodiment, the LC PUFA content of the blend is between about 1% and about 30%. In this embodiment, the LC PUFA content of the oil blend can also be between about 10% and about 20%, or between about 1% and about 5%. The second food oil composition embodiment can be used in a method for preparing a food product that includes contacting an oil with additional food components. Such food products can include any edible lipid-containing food sauce, such as salad dressings, marinades, remoulades, vegetable sauces, fruit sauces, fish sauces, and meat sauces, such as poultry sauces, beef sauces, veal sauces, and lamb sauces.

A third food oil composition embodiment of the present invention includes a topical food oil composition that includes a blend of a first oil having an LC PUFA and preferably, an omega-3 LC PUFA, an omega-6 LC PUFA or mixtures thereof, a second oil comprising substantially no LC PUFAs and preferably, no omega-3 LC PUFAs and substantially no omega-6 LC PUFAs, and that is liquid at room temperature and an antioxidant. In this embodiment, the blend comprises between about 0.25% and about 10% LC PUFA. In this embodiment, the LC PUFA content of the blend can also be between about 1% and about 5%. A further embodiment of the present invention is a food product comprising the third food oil composition embodiment. The food product can be selected from a previously cooked food product, such as one that was previously baked, fried, or deep-fried. The food product can be selected from baked goods, salted snacks, specialty snacks, confectionary snacks, and naturally occurring snack foods. For example, the food product can be selected from cookies, crackers, sweet goods, muffins, cereals, snack cakes, pies, granola/snack bars, toaster pastries, potato chips, corn chips, wheat chips, sorghum chips, soy chips, extruded snacks, popcorn, pretzels, potato crisps, dried fruit snacks, meat snacks, pork rinds, health food bars, rice cakes, corn cakes, candy, nuts, dried fruits and vegetables.

A further embodiment of the present invention is a method of food preparation that includes topically applying the third food oil composition embodiment to a food product. The step of topically applying can be selected from spraying, dipping and brushing. This method can further include packaging the food product after application of the food oil composition. The step of packaging can include packaging the food product in an inert atmosphere. Such an atmosphere can include nitrogen or can include nitrogen and carbon dioxide.

All of the food oil composition embodiments of the present invention can further include an antioxidant, which can be selected from Vitamin E, BHT, BHA, TBHQ, propyl gallate, Vitamin C, phospholipids and natural antioxidants and combinations thereof. Preferred antioxidants include BHA, BHT, TBHQ, a blend of BHA/BHT, and combinations thereof, and particularly, TBHQ. In preferred embodiments, the antioxidant can be present in the oil blend in an amount between about 0.01% and about 1% and alternatively between about 0.1% and about 0.5%.

In various embodiments of the food oil compositions, the second oil can be selected from borage oil, black currant seed oil, corn oil, coconut oil, canola oil, soybean oil, safflower oil, high oleic safflower oil, sunflower oil, high oleic sunflower oil, olive oil, evening primrose oil, cottonseed oil, rice bran oil, grapeseed oil, flaxseed oil, garlic oil, peanut oil, almond oil, walnut oil, wheat germ oil, sesame oil, animal fat, animal oil, marine fat, marine oil, microbial oil, a hydrogenated oil of any of the foregoing, and mixtures of the foregoing. The omega-3 LC PUFA and/or omega-6 LC PUFA in various embodiments of the present invention can be selected from docosahexaenoic acid, eicosapentaenoic acid, docosapentaenoic acid, and arachidonic acid (ARA). In various embodiments, the first oil can be from a microbial source, such as algae, protists, bacteria and fungi. The microbial source can be an oleaginous microorganism. The microbial source can be selected from microorganisms of the genus Thraustochytrium, microorganisms of the genus Schizochytrium, microorganisms of the genus Althomia, microorganisms of the genus Aplanochytrium, miscroorganisms of the genus Japonochytrium, microorganisms of the genus Elina, microorganisms of the genus Crypthecodinium, and microorganisms of the genus Mortierella. In preferred embodiments, the microorganism is selected from microorganisms of the genus Schizochytrium, microorganisms of the genus Crypthecodinium, and microorganisms of the genus Mortierella.

The first oil can also be from a plant source, such as plants that have been genetically modified to produce LC PUFAs, wherein the plant is selected from soybean, corn, safflower, sunflower, canola, flax, peanut, mustard, grapeseed, chick pea, cotton, lentil, white clover, olive, palm, borage, evening primrose, linseed and tobacco.

In a further embodiment, the first oil can be from an animal source, which can be selected from aquatic animals, lipids extracted from animal tissues and animal products. Further, the first oil can include at least about 20% omega-3 LC PUFAs and/or omega-6 LC PUFAs or at least about 60% omega-3 LC PUFAs and/or omega-6 LC PUFAs.

### BRIEF DESCRIPTION OF THE DRAWINGS

FIG. 1 illustrates the results of consumer testing of food products (fried potatoes, omelets and fried French toast) of the present invention.

FIG. 2 illustrates the effect on OSI induction period of blending various vegetable oils with an omega-3 LC PUFA-containing oil.

FIG. 3 illustrates the effect on OSI induction period of blending various vegetable oils with an omega-3 LC PUFA-containing oil, with and without antioxidants.

FIG. 4 illustrates the effect on production of primary oxidation products of blending corn oil with an omega-3 LC PUFA-containing oil, with and without antioxidants.

FIG. 5 illustrates the effect on production of secondary oxidation products of blending corn oil with an omega-3 LC PUFA-containing oil, with and without antioxidants.

FIG. 6 illustrates the effect on OSI induction period of blending corn oil with an omega-3 LC PUFA-containing oil.

FIG. 7 illustrates the effect on OSI induction period of blending soybean oil with an omega-3 LC PUFA-containing oil.

FIG. 8 illustrates the effect on OSI induction period of blending canola oil with an omega-3 LC PUFA-containing oil.

FIG. 9 illustrates the effect on OSI induction period of blending safflower oil with an omega-3 LC PUFA-containing oil.

FIG. 10 illustrates the effect on OSI induction period of blending sunflower oil with an omega-3 LC PUFA-containing oil.

FIG. 11 illustrates the peroxide values of a blend of corn oil and an omega-3 LC PUFA-containing oil over time.

FIG. 12 illustrates the alkenal values of a blend of corn oil and an omega-3 LC PUFA-containing oil over time.

FIG. 13 illustrates the DHA content of a blend of corn oil and an omega-3 LC PUFA-containing oil over time.

### DETAILED DESCRIPTION

The food oil and food product compositions, methods for food preparation, and methods for enhancing the LC PUFA content and preferably, the omega-3 LC PUFA and/or omega-6 LC PUFA content of previously prepared food products, as taught by the present invention, provide for increased intake of LC PUFAs and particularly omega-3 LC PUFAs and/or omega-6 LC PUFAs. This improvement can provide health benefits to those consuming such products. The present invention also provides methods to minimize the oxidative degradation of LC PUFAs in the food products and food oil compositions.

In various embodiments, the present invention includes a food oil composition comprising a blend of a first oil comprising an LC PUFA and preferably, an omega-3 LC PUFA and/or omega-6 LC PUFA and a second oil comprising substantially no LC PUFA and preferably, substantially no omega-3 LC PUFA and substantially no omega-6 LC PUFA that is liquid at room temperature. In a first embodiment, the blend comprises between about 0.01% and about 5% LC PUFAs. This embodiment of the food oil composition is particularly useful for fast frying food, such as in a skillet, to impart LC PUFAs and preferably, omega-3 LC PUFAs, omega-6 LC PUFAs or mixtures thereof into a diet. In an alternate embodiment, this food oil composition is useful for preparing deep-fried food products, such as tempura or fries, in which the food item is immersed in the oil. In a second food oil composition embodiment, the LC PUFA and preferably, the omega-3 LC PUFA and/or omega-6 LC PUFA content of the blend is between about 1% and about 30%. This second food oil composition embodiment is particularly useful in food products such as edible lipid-containing food sauces, such as salad dressings, marinades, remoulades, vegetable sauces, fruit sauces, fish sauces, and meat sauces. In a third food oil composition embodiment, the blend comprises between about 0.25% and about 10% LC PUFA and preferably, omega-3 LC PUFA and/or omega-6 LC PUFA and the composition further includes an antioxidant. This third embodiment is particularly useful for topical application of the composition to foods, such as baked goods, salted snacks, specialty snacks, confectionary snacks, and naturally occurring snack foods. Such foods with topical applications of the oil composition are typically packaged products and are packaged in an inert atmosphere.

A food oil preferably contains greater than about 90% fatty acids by weight, whereas a product such as margarine and butter is typically an emulsion of fat and water having a fatty acid content of between about 80% by weight and about 95% by weight. As used herein, all percentages are given by weight unless explicitly stated otherwise.

The oil blend of the present invention includes a first oil that comprises an LC PUFA, and preferably an omega-3 LC PUFA, an omega-6 LC PUFA or mixtures thereof. Preferred omega-3 LC PUFAs include, for example, docosahexaenoic acid C22:6(n-3) (DHA), eicosapentaenoic acid C20:5(n-3)(EPA), and docosapentaenoic acid C22:5(n-3) (DPA). DHA is particularly preferred. Preferred omega-6 LC-PUFAs include arachidonic acid C20:4(n-6) (ARA). The PUFAs can be in any of the common forms found in natural lipids including but not limited to triacylglycerols, diacylglycerols, phospholipids, free fatty acids, esterified fatty acids, or in natural or synthetic derivative forms of these fatty acids (e.g. calcium salts of fatty acids, ethyl esters, etc). Reference to a first oil comprising an omega-3 LC PUFA and/or omega-6 LC PUFA, as used in the present invention, can refer to either an oil comprising only a single omega-3 LC PUFA and/or omega-6 LC PUFA such as DHA or an oil comprising a mixture of omega-3 LC PUFAs and/or omega-6 LC PUFA such as DHA and EPA, or DHA and ARA.

A preferred source of oils that comprise LC PUFAs and preferably, omega-3 LC PUFAs and/or omega-6 LC PUFAs, in the compositions and methods of the present invention includes a microbial source. Microbial sources and methods for growing microorganisms comprising nutrients and/or LC PUFAs are known in the art (Industrial Microbiology and Biotechnology, 2^{nd} edition, 1999, American Society for Microbiology). Preferably, the microorganisms are cultured in a fermentation medium in a fermentor. The methods and compositions of the present invention are applicable to any industrial microorganism that produces any kind of nutrient or desired component such as, for example algae, protists, bacteria and fungi (including yeast).

Microbial sources can include microorganisms such as algae, bacteria, fungi and/or protists. Preferred organisms include those selected from the group consisting of golden algae (such as microorganisms of the kingdom Stramenopiles), green algae, diatoms, dinoflagellates (such as microorganisms of the order Dinophyceae including members of the genus Crypthecodinium such as, for example, Crypthecodinium cohnii), yeast, and fungi of the genera Mucor and Mortierella, including but not limited to Mortierella alpina and Mortierella sect. schmuckeri. Members of the microbial group Stramenopiles include microalgae and algae-like microorganisms, including the following groups of microorganisms: Hamatores, Proteromonads, Opalines, Develpayella, Diplophrys, Labrinthulids, Thraustochytrids, Biosecids, Oomycetes, Hypochytridiomycetes, Commation, Reticulosphaera, Pelagomonas, Pelagococcus, Ollicola, Aureococcus, Parmales, Diatoms, Xanthophytes, Phaeophytes (brown algae), Eustigmatophytes, Raphidophytes, Synurids, Axodines (including Rhizochromulinaales, Pedinellales, Dictyochales), Chrysomeridales, Sarcinochrysidales, Hydrurales, Hibberdiales, and Chromulinales. This detailed description of the invention will discuss processes for growing microorganisms which are capable of producing lipids comprising omega-3 and/or omega-6 polyunsaturated fatty acids, in particular microorganisms that are capable of producing DHA (or closely related compounds such as DPA, EPA or ARA). Additional preferred microorganisms are algae, such as Thraustochytrids of the order Thraustochytriales, more specifically Thraustochytriales, including Thraustochytrium, Schizochytrium and Ulkenia, and including Thraustochytriales which are disclosed in commonly assigned U.S. Pat. Nos. 5,340,594 and 5,340,742, both issued to Barclay, all of which are incorporated herein by reference in their entirety, in addition to microorganisms of the genus Althornia, genus Aplanochytrium, genus Japonochytrium, and genus Elina and mixtures thereof. More preferably, the microorganisms are selected from the group consisting of microorganisms having the identifying characteristics of ATCC number 20888, ATCC number 20889, ATCC number 20890, ATCC number 20891 and ATCC number 20892, strains of Mortierella schmuckeri and Mortierella alpina, strains of Crypthecodinium cohnii, mutant strains derived from any of the foregoing, and mixtures thereof. It should be noted that many experts agree that Ulkenia is not a separate genus from the genus Thraustochytrium. Accordingly, as used herein, the genus Thraustochytrium will include Ulkenia. Oleaginous microorganisms are also preferred. As used herein, “oleaginous microorganisms” are defined as microorganisms capable of accumulating greater than 20% of the weight of their cells in the form of lipids. Genetically modified microorganisms that produce LC PUFAs are also suitable for the present invention. These can include naturally LC PUFA-producing microorganisms that have been genetically modified as well as microorganisms that do not naturally produce LC PUFAs (including yeast, bacteria, fungi, algae and/or protists) but that have been genetically engineered to do so.

Suitable organisms may be obtained from a number of available sources, including by collection from the natural environment. For example, the American Type Culture Collection currently lists many publicly available strains of microorganisms identified above. As used herein, any organism, or any specific type of organism, includes wild strains, mutants, or recombinant types. Growth conditions in which to culture or grow these organisms are known in the art, and appropriate growth conditions for at least some of these organisms are disclosed in, for example, U.S. Pat. No. 5,130,242, U.S. Pat. No. 5,407,957, U.S. Pat. No. 5,397,591, U.S. Pat. No. 5,492,938, and U.S. Pat. No. 5,711,983, all of which are incorporated herein by reference in their entirety.

Another preferred source of oils comprising LC PUFAs includes a plant source, such as oilseed plants. Since plants do not naturally produce LC PUFAs, plants producing LC PUFAs are those genetically engineered to express genes that produce LC PUFAs. Such genes can include genes encoding proteins involved in the classical fatty acid synthase pathways, or genes encoding proteins involved in the PUFA polyketide synthase (PKS) pathway. The genes and proteins involved in the classical fatty acid synthase pathways, and genetically modified organisms, such as plants, transformed with such genes, are described, for example, in Napier and Sayanova, Proceedings of the Nutrition Society (2005), 64:387-393; Robert et al., Functional Plant Biology (2005) 32:473-479; or U.S. Patent Application Publication 2004/0172682. The PUFA PKS pathway, genes and proteins included in this pathway, and genetically modified microorganisms and plants transformed with such genes for the expression and production of PUFAs are described in detail in: U.S. Pat. No. 6,566,583; U.S. Patent Application Publication No. 20020194641, U.S. Patent Application Publication No. 20040235127A1, and U.S. Patent Application Publication No. 20050100995A1, each of which is incorporated herein by reference in its entirety.

Preferred oilseed crops include soybeans, corn, safflower, sunflower, canola, flax, peanut, mustard, rapeseed, chickpea, cotton, lentil, white clover, olive, palm oil, borage, evening primrose, linseed, and tobacco that have been genetically modified to produce LC PUFA as described above.

Genetic transformation techniques for microorganisms and plants are well-known in the art. Transformation techniques for microorganisms are well known in the art and are discussed, for example, in Sambrook et al., 1989, Molecular Cloning: A Laboratory Manual, Cold Spring Harbor Labs Press. A general technique for transformation of dinoflagellates, which can be adapted for use with Crypthecodinium cohnii, is described in detail in Lohuis and Miller, The Plant Journal (1998) 13(3): 427-435. A general technique for genetic transformation of Thraustochytrids is described in detail in U.S. Patent Application Publication No. 20030166207, published Sept. 4, 2003. Methods for the genetic engineering of plants are also well known in the art. For instance, numerous methods for plant transformation have been developed, including biological and physical transformation protocols. See, for example, Miki et al., “Procedures for Introducing Foreign DNA into Plants” in Methods in Plant Molecular Biology and Biotechnology, Glick, B. R. and Thompson, J. E. Eds. (CRC Press, Inc., Boca Raton, 1993) pp. 67-88. In addition, vectors and in vitro culture methods for plant cell or tissue transformation and regeneration of plants are available. See, for example, Gruber et al., “Vectors for Plant Transformation” in Methods in Plant Molecular Biology and Biotechnology, Glick, B. R. and Thompson, J. E. Eds. (CRC Press, Inc., Boca Raton, 1993) pp. 89-119. See also, Horsch et al., Science 227:1229 (1985); Kado, C. I., Crit. Rev. Plant. Sci. 10:1 (1991); Moloney et al., Plant Cell Reports 8:238 (1989); U.S. Pat. No. 4,940,838; U.S. Pat. No. 5,464,763; Sanford et al., Part. Sci. Technol. 5:27 (1987); Sanford, J. C., Trends Biotech. 6:299 (1988); Sanford, J. C., Physiol. Plant 79:206 (1990); Klein et al., Biotechnology 10:268 (1992); Zhang et al., Bio/Technology 9:996 (1991); Deshayes et al., EMBO J., 4:2731 (1985); Christou et al., Proc Natl. Acad. Sci. USA 84:3962 (1987); Hain et al., Mol. Gen. Genet. 199:161 (1985); Draper et al., Plant Cell Physiol. 23:451 (1982); Donn et al., In Abstracts of VIIth International Congress on Plant Cell and Tissue Culture IAPTC, A2-38, p. 53 (1990); D'Halluin et al., Plant Cell 4:1495-1505 (1992) and Spencer et al., Plant Mol. Biol. 24:51-61 (1994).

When oilseed plants are the source of LC PUFAs, the seeds can be harvested and processed to remove any impurities, debris or indigestible portions from the harvested seeds. Processing steps vary depending on the type of oilseed and are known in the art. Processing steps can include threshing (such as, for example, when soybean seeds are separated from the pods), dehulling (removing the dry outer covering, or husk, of a fruit, seed, or nut), drying, cleaning, grinding, milling and flaking. After the seeds have been processed to remove any impurities, debris or indigestible materials, they can be added to an aqueous solution preferably water, and then mixed to produce a slurry. Preferably, milling, crushing or flaking is performed prior to mixing with water. A slurry produced in this manner can be treated and processed the same way as described for a microbial fermentation broth. Size reduction, heat treatment, pH adjustment, pasteurization and other known treatments can be used in order to improve quality (nutritional and sensory).

Another preferred source of oils that comprise LC PUFAs includes an animal source. Examples of animal sources include aquatic animals (e.g., fish, marine mammals, and crustaceans such as krill and other euphausids) and animal tissues (e.g., brain, liver, eyes, etc.) and animal products (e.g., eggs and milk). Techniques for recovery of LC PUFA containing oils from such sources are known in the art.

Preferably, the first oil comprises at least about 20% LC PUFA, at least about 30% LC PUFA, at least about 40% LC PUFA, at least about 50% LC PUFA, at least about 60% LC PUFA, at least about 70% LC PUFA, and at least about 80% LC PUFA.

The oil blend of the present invention includes a second oil that can include any oil known in the art. Such oils include, for example, oils derived from plants, such as borage, black currant seed, corn, coconut, canola, soybean, safflower, high oleic safflower, sunflower, high oleic sunflower, olive, evening primrose, cottonseed, rice bran, grapeseed, flaxseed, garlic, peanuts, almonds, walnuts, wheat germ, and sesame. Such vegetable sources naturally produce fatty acids only to about 18 carbons. Additional oils suitable as the second oil of the oil composition includes animal fats and oils, marine fats and oils, microbiological oils, and combinations of any of these oils and fats. Most preferably, the balance of the oil composition in the first oil composition comprises the following oils/fats: corn oil, soy oil, canola oil, cottonseed oil, sunflower oil, high oleic sunflower oil, safflower oil, high oleic safflower oil, and olive oil. Hydrogenated oils may also be used as the second oil of the oil composition, however, hydrogenated oils are not as preferred as non-hydrogenated oils. Without intending to be bound by theory, in various embodiments of the present invention, the blending of the second oil with the first oil increases the oxidative stability of the first oil (e.g., as measured by increases in the OSI induction period and/or the production of primary and/or secondary oxidation products under mild accelerated conditions). Particularly, in the instance in which the second oil is corn oil, soybean oil or canola oil, the oxidative stability of the first oil can be improved.

In some embodiments, the composition is stable to oxidation for a period of time when stored at room temperature. The period of time can be at least about one month, about two months, about three months, about four months, about five months, about six months, about seven months, about eight months, about nine months, about ten months, about eleven months and about twelve months. By stable, it is meant that the levels of oxidation products, such as peroxides and/or alkenals, do not increase appreciably in the time interval. For example, the level of an oxidation products measured as peroxides, typically will be less than about 3.0 meq/kg fat, less than about 2.5 meq/kg fat, less than about 2.0 meq/kg fat, less than about 1.5 meq/kg fat, less than about 1.0 meq/kg fat, less than about 0.5 meq/kg fat, or less than about 0.25 meq/kg fat over the various time frames referenced above.

In addition to oxidative stability, the LC-PUFA level in the composition is stable for a period of time when stored at room temperature. The period of time can be at least about one month, about two months, about three months, about four months, about five months, about six months, about seven months, or about eight months. By stable, it is meant that the levels of LC-PUFA do not decrease appreciably in the time interval. For example, the level of LC-PUFA that can be recovered after the various time frames referenced above is at least about 60%, at least about 65%, at least about 70%, at least about 75%, at least about 80%, at least about 85%, at least about 90%, at least about 95%, and at least about 99%.

In addition, the sensory characteristics of the composition remain constant over a period of time when stored at room temperature. By constant, it is meant that the sensory characteristic measured (e.g., greenibeany, fishy, painty, herbal, or other) does not change significantly over a period of time. The period of time can be at least about one month, about two months, about three months, about four months, about five months, about six months, about seven months, or about eight months. For example, a negative sensory characteristic typically will increase less than about 100%, less that about 75%, less that about 50%, less that about 40%, less that about 30%, less that about 25%, less that about 20%, less that about 15%, less that about 10%, or less than about 5%, over the various time frames referenced above.

The second oil comprises substantially no LC PUFA and preferably substantially no omega-3 LC PUFA and substantially no omega-6 LC PUFA. Generally, reference to substantially no LC PUFA includes oils having less than about 5% LC PUFA, less than about 3% LC PUFA, less than about 1% LC PUFA, less than about 0.1% LC PUFA, or less than about 0.01% LC PUFA. The second oil is preferably also liquid at room temperature (approximately 21° C.-23° C.).

Blending the first oil and the second oil can be performed by any method known in the art. Blending can be done by: 1) batch or 2) continuous in-line mixing. Batch mixing can include using a stainless steel container, with an agitator, and if possible, the container is blanketed with nitrogen during the blending operation. The second oil (substantially no LC PUFA) is typically added first with agitation at a speed that does not create vortices until a steady state is attained. The first oil (with LC PUFA) is then added until completely mixed in. Agitation preferably can continue for about 3 to 5 minutes (times may vary for different sized containers) until a mixture, homogeneous in appearance, is obtained. Synthetic antioxidants can be added to enhance dispersion and dissolution of the first and second oils, for example, at the start of agitation. In the case of continuous mixing, the first oil (typically, lower volume) can be added at mixing point, depending on the in-line mixing equipment used, and will be added at a rate to produce a desired composition. Synthetic antioxidants can be pre-dissolved in the second oil, preferentially, but can also be introduced into the first oil assuming the desired amounts of antioxidants can be dissolved completely.

The food oil compositions and food products comprising the food oil compositions of the present invention can have an LC PUFA content such that an individual serving of a food product comprising the food oil compositions of the present invention has an appropriate amount of LC PUFA per serving. Appropriate amounts of LC PUFAs and preferably, omega-3 LC PUFA and/or omega-6 LC PUFA per serving are known in the art. For example, preferred amounts of omega-3 LC PUFA and/or omega-6 LC PUFA per serving include amounts of omega-3 LC PUFA and/or omega-6 LC PUFA between about 5 mg per serving and about 150 mg per serving; between about 10 mg per serving and about 100 mg per serving; between about 25 mg per serving and about 75 mg per serving; and between about 35 mg per serving and about 50 mg per serving.

The final concentration of LC PUFA in the blend can vary depending on the use or purpose of the oil and the amount of LC PUFA desired per serving. For example, a food product comprising a significant percentage by weight of oil, thus resulting in a relatively greater amount of oil per serving, will require an oil composition that has a relatively smaller percentage of LC PUFA. Knowing the approximate amount of LC PUFA desired per serving and the amount of oil per serving, the skilled artisan can make the necessary calculations to determine the appropriate percentage of LC PUFA in the oil blend.

In the first embodiment, such as where the oil blend is to be used as a fast frying oil, the blend can have an LC PUFA and preferably, an omega-3 LC PUFA and/or omega-6 LC PUFA content in an amount between about 0.01% and about 5%, between about 0.8% and about 3%, and between about 0.1% and about 0.5%. When the oil blend is to be used in food products, for example, as an edible lipid-containing food sauce, preferably, the blend can have an LC PUFA and preferably, an omega-3 LC PUFA and/or omega-6 LC PUFA content in an amount between about 1% and about 30%, between about 10% and about 20%, and between about 1% and about 5%. When the oil blend is to be used in food products, for example, in an embodiment wherein the oil blend is sprayed onto a food product as a topical oil, the blend can have an LC PUFA and preferably, an omega-3 LC PUFA and/or omega-6 LC PUFA between about 0.25% and about 10% and between about 1% and about 5%.

In preferred embodiments, the blend comprises oil components that are not LC PUFAs and specifically, not omega-3 LC PUFA nor omega-6 LC PUFA having 20 or more carbons in an amount of at least about 70%, at least about 80%, at least about 90%, and at least about 95%.

In preferred embodiments, the food oil compositions and food products of the present invention comprise an antioxidant, and methods for food preparation comprise the addition of an antioxidant. In particular, in the embodiment of a topical food oil composition of the present invention, an antioxidant is part of the composition. In other embodiments, antioxidants can be used, but are optional. Any antioxidant suitable for food oils or fats preservation known in the art is compatible with the present invention, and include vitamin E, butylhydroxytoluene (BHT), butylhydroxyanisole (BHA), tert-butylhydroquinone (TBHQ), propyl gallate (PG), vitamin C (as used herein, reference to vitamin C includes derivatives thereof), phospholipids, and natural antioxidants such as rosemary extract, and combinations thereof. Preferred antioxidants include BHA, BHT, TBHQ, a blend of BHA/BHT, and combinations thereof, and particularly, TBHQ. Amounts of antioxidant to include in the composition will vary depending on the application as determined by one skilled in the art. For example, food oil compositions of the present invention comprising relatively greater amounts of LC PUFAs and preferably, omega-3 LC PUFAs and/or omega-6 LC PUFAs (having 20 or more carbons) preferably contain higher amounts of antioxidant, such as, for example, amounts up to the maximum allowed by current United States law. Antioxidants may be added to or blended with the oil by any method known in the art. Preferred amounts of antioxidant in the oil compositions of the present invention include amounts between about 0.01% and about 1%, and between about 0.1% and about 0.5%.

In preferred embodiments, the food oil compositions and food products of the present invention are stored under appropriate conditions to minimize oxidative degradation. Many methods to effect such storage conditions are known in the art and are suitable for use with the present invention, such as, for example, replacement of ambient air with an inert gas atmosphere. A preferred method by which to reduce or minimize oxidative degradation is to store food oil compositions and food products under a nitrogen (N₂) atmosphere or mixed nitrogen and carbon dioxide atmosphere. Preferably, packaged food oil compositions and food products are packaged under nitrogen. Methods for producing a nitrogen gas atmosphere into a food container are known in the art.

In another embodiment, the present invention includes a method for food preparation for a food item capable of being skillet-fried, comprising placing the food item and an oil blend of the present invention onto the skillet, and applying heat to the skillet sufficient to heat the food item. Suitable food items include any food item that is capable of being skillet-fried with an oil, and includes, for example, meats, eggs (e.g., omelets), fish, vegetables, starchy tubers such as potatoes, rice, doughs, batters, breads, batter-coated breads (e.g., French toast), corn products, and mixtures of the foregoing. The term “skillet” refers to any cooking utensil that is suitable for heating food items, and more particularly refers to a wide metal or tempered-glass vessel. A suitable proportion of food and oil for use in the invention may be determined by one skilled in the art. This embodiment additionally includes a skillet-fried food product comprising an oil blend of the present invention.

In another embodiment, the present invention includes a method for preparing an oil blend of the present invention, wherein the oil blend is contacted with other food components to make a variety of products such as any edible lipid-containing food sauce, such as salad dressings, marinades, remoulades, vegetable sauces, fruit sauces, fish sauces, and meat sauces, such as poultry sauces, beef sauces, veal sauces, and lamb sauces. This method includes mixing a first oil comprising an LC PUFA and preferably, an omega-3 LC PUFA and/or omega-6 LC PUFA with additional components conventionally found in those products such as spices, flavorings, thickeners, and emulsifiers. Suitable recipes and methods of combining the first oil and additional components are known in the art.

In another embodiment, the present invention includes a method for enhancing the LC PUFA and preferably, the omega-3 PUFA and/or omega-6 LC PUFA content of a food product, comprising applying an oil blend of the present invention to the food product. By this method, the LC PUFA content of the food product is enhanced, without subjecting the LC PUFAs to harsh thermal processes during cooking. Such a method can produce food products having a shelf life of approximately 6 months or more. A preferred food product is a previously cooked food product. Preferred previously cooked food products include food products that were previously baked, fried, or deep-fried. The oil blend of the present invention may be applied to the food product by any method known in the art, such as spraying the food product with the oil, dipping the food product into the oil, and brushing the oil onto the surface of the food product. Preferably, the oil is sprayed onto the surface of the food product. Preferred food products include baked goods such as cookies, crackers, sweet goods, muffins, cereals, snack cakes, pies, granola/snack bars, and toaster pastries; salted snacks such as potato chips, corn chips, tortilla chips, extruded snacks, popcorn, pretzels, potato crisps, and nuts; specialty snacks such as dried fruit snacks, meat snacks, pork rinds, health food bars, rice cakes and corn cakes; confectionary snacks such as candy; and naturally occurring snack foods such as nuts, dried fruits and vegetables. Preferred food products include cookies, crackers, potato chips, corn chips, wheat chips, sorghum chips, soy chips and nuts. This embodiment additionally includes a previously cooked food product comprising an oil blend of the present invention.

In another embodiment, the present invention includes a method for enhancing the PUFA content of a food product, comprising applying an oil blend of the present invention to a food product intended for consumption by infants or toddlers. For instance, snack foods containing ARA are suitable for consumption by children that are still consuming infant formula, but who are also starting to eat solid foods. In some of these embodiments, ratios of DHA:ARA in oils of the present invention are from about 1:0.5 to about 1:5. Additional ratios are at about 1:1.5, at about 1:2 and at about 1:3.

The following examples and test results are provided for the purposes of illustration and are not intended to limit the scope of the invention.

### EXAMPLES

### Example 1

The example illustrates an embodiment of the present invention in which a blend of oils is used for frying various foods.

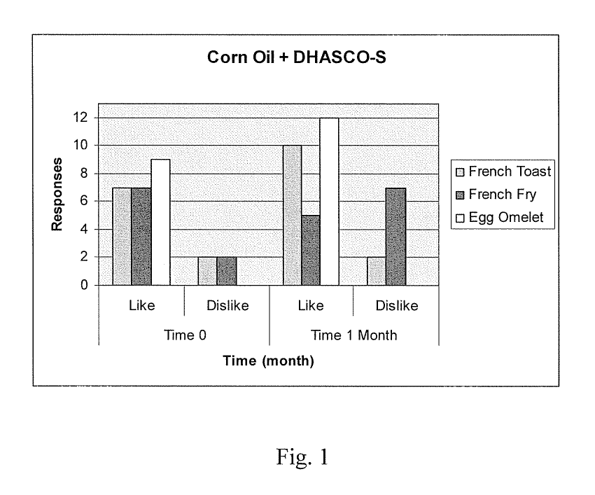

800 g of a blend of oils was prepared by mixing 799.2 g of commercially available corn oil with 0.8 g of DHASCO®-S oil (Martek Biosciences Corporation, Columbia, Md.). DHASCO®-S comprises approximately 35% by weight DHA, resulting in an omega-3 content of about 0.035%. Fried potatoes (French fried style), omelets and fried French toast were prepared using this oil blend and tested for consumer acceptability by a consumer panel of nine or twelve people. The oil blend was stored for one month at room temperature and then was re-tested preparing the same foods as before. The results of the consumer testing are shown in FIG. 1. The amount of DHA per serving of food product, as well as the oil before and after deep frying, was analyzed and is shown below in Table 1.

TABLE 1

| | DHA |
|---|---|
| Sample | mg/serving |
| French fry | 4.6 |
| (100 g serving) | |
| French toast | 10.9 |
| (50 g serving) | |
| Egg | 56 |
| (100 g serving) | |
| Oil Before | 0.5 |
| Frying (1 g) | |
| Oil After | 0.5 |
| Frying (1 g) | |

From the results in FIG. 1, it can be seen that the French toast and omelet had 100% or almost 100% “Like” response in the consumer acceptability testing both at time zero and after one month, indicating that after one month, the oil was still in excellent condition. In the case of the French fries, although >50% provided a “Dislike” response after one month, the majority of the comments were neutral (e.g., related to an oily flavor or a different flavor), with <50% of the total attributing the “Dislike” rating to a negative comment (e.g., fishiness). Therefore, the “Dislike” ratings can be attributed to the corn oil aging rather than the omega-3 portion of the oil being degraded and providing off flavors.

### Example 2

This example examines the effect on the oxidative stability of an oil containing an omega-3 LC PUFA of blending a vegetable oil containing substantially no omega-3 LC PUFA and substantially no omega-6 LC PUFA.

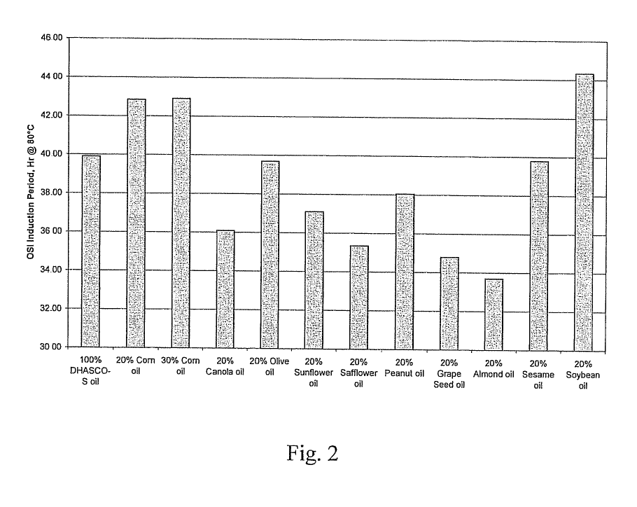

An oil containing about 35% by weight DHA (DHASCO®-S, Martek Biosciences Corporation, Columbia, Md.) was diluted with 20% of various vegetable oils and 30% corn oil as shown in FIG. 2. The DHASCO®-S oil and the blended oils were tested for the time to the OSI induction period, measured in hours. The oils were kept at 80° C. with air bubbled through and evaluated for the time until the oil begins to oxidize.

The results of this testing are shown in FIG. 2 in which it is shown that at 20% corn oil and soybean oil and 30% corn oil, an increase in the OSI induction period was achieved.

### Example 3

This example examines the effect on the oxidative stability of an oil containing an omega-3 LC PUFA of blending corn oil, with and without added antioxidants.

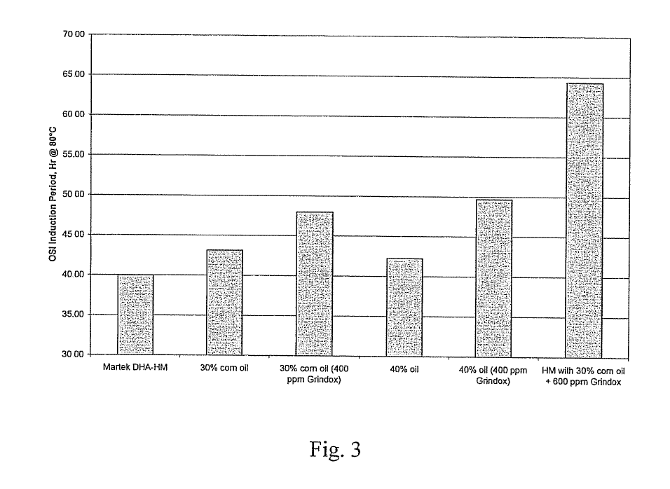

An oil containing about 32% by weight DHA (DHA-HM, Martek Biosciences Corporation, Columbia, Md.) was diluted with 30% or 40% of corn oil, with and without the addition of 400 ppm or 600 ppm of an antioxidant blend of ascorbyl palmitate and tocopherols (Grindox™, Danisco) as shown in FIG. 3. The DHA-HM oil and the corn oil blends were tested for the time to the OSI induction period, measured in hours. The oils were kept at 80° C. with air bubbled through and evaluated for the time until the oil begins to oxidize.

The results of this testing are shown in FIG. 3 in which it is shown that all of the corn oil blends, with and without antioxidant increased the OSI induction period.

### Example 4

This example examines the effect on the oxidative stability of an oil containing an omega-3 LC PUFA of blending corn oil, with and without added antioxidants.

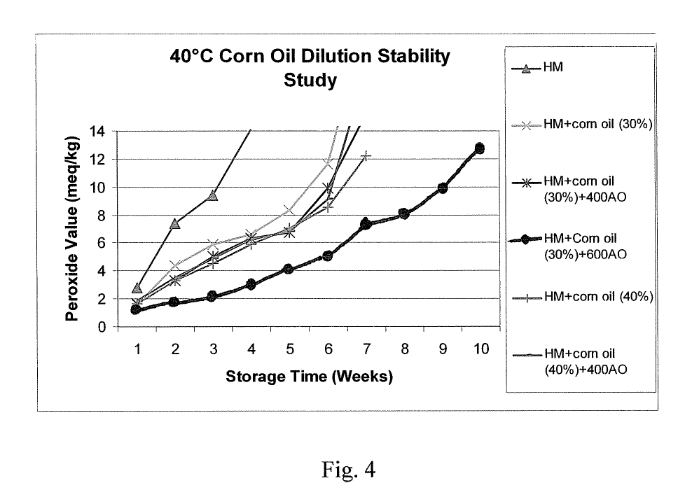

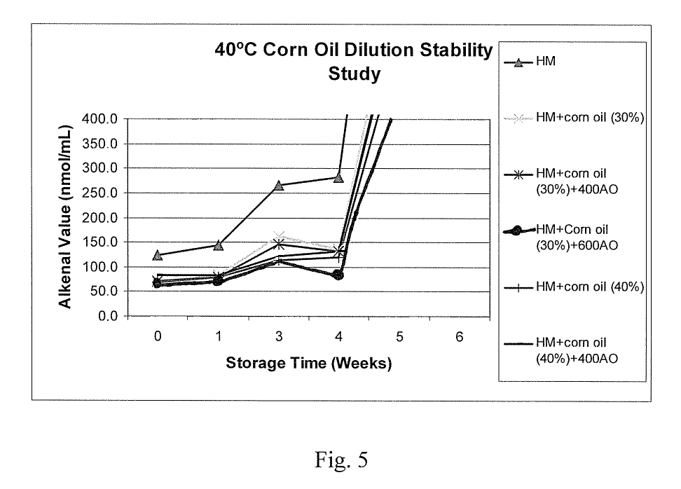

An oil containing about 32% by weight DHA (DHA-HM, Martek Biosciences Corporation, Columbia, Md.) was diluted with 30% or 40% of corn oil, with and without the addition of 400 ppm or 600 ppm of an antioxidant blend of ascorbyl palmitate and tocopherols (Grindox™, Danisco) as shown in FIGS. 4 and 5. The DHA-HM oil and the corn oil blends were stored at 40° C. over a period of weeks and tested for the production of peroxides (primary oxidation products) and alkenals (secondary oxidation products).

The results of this testing are shown in FIGS. 4 and 5 in which it is shown that all of the corn oil blends, with and without antioxidant, delayed the occurrence of primary and secondary oxidation products.

### Example 5

This example examines the effect on the oxidative stability of an oil containing an omega-3 LC PUFA of blending vegetable oils containing substantially no omega-3 LC PUFA and substantially no omega-6 LC PUFA.

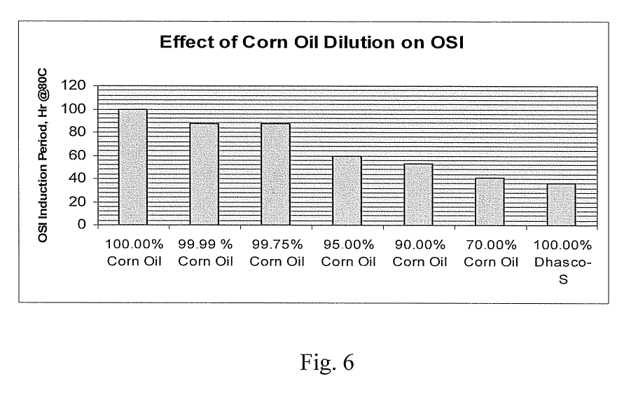

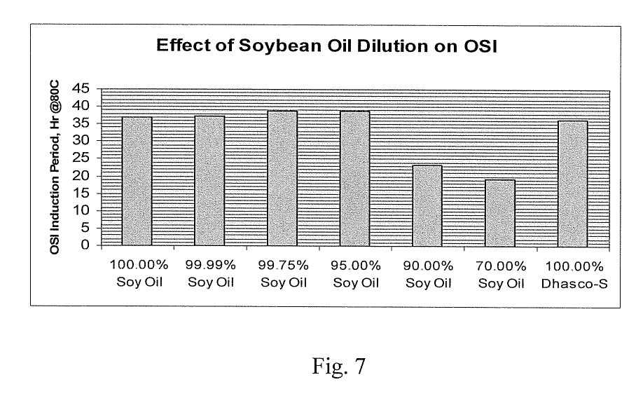

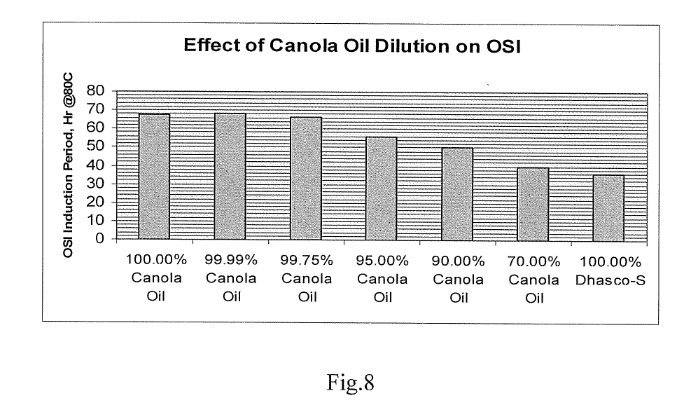

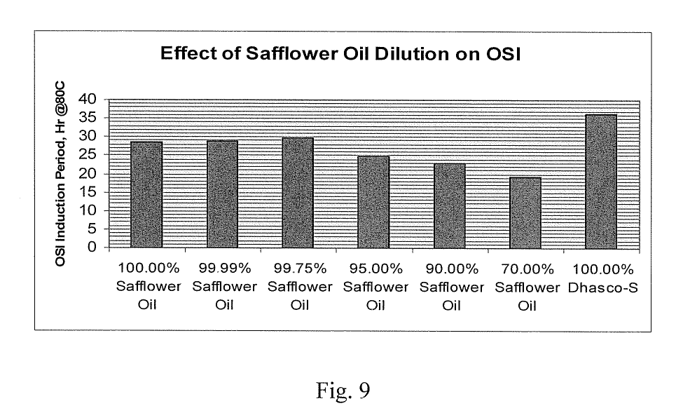

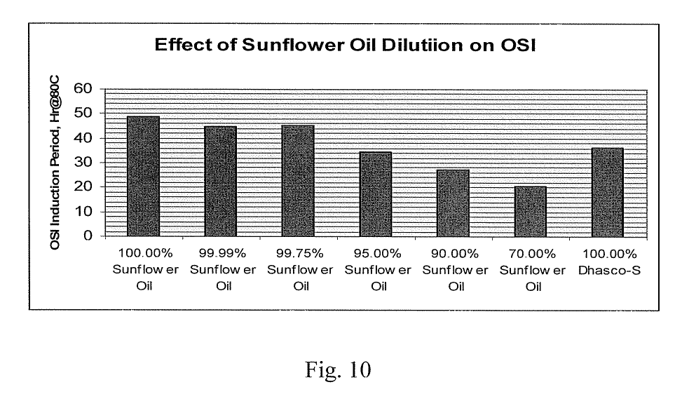

Five commonly used vegetable oils were combined with an oil containing about 35% by weight DHA (DHASCO®-S, Martek Biosciences Corporation, Columbia, Md.) at five dilution levels. The DHASCO®-S oil, the vegetable oil and the blended oils were tested for the time to the OSI induction period, measured in hours. The oils were kept at 80° C. with air bubbled through and evaluated for the time until the oil begins to oxidize. The oils, dilution levels and OSI values are shown below in Tables 2-6. The results are also shown in FIGS. 6-10.

TABLE 2

| Oil | OSI Value |
|---|---|
| 100.00% Corn Oil | 99.9 |
| 99.99% Corn Oil | 87.5 |
| 99.75% Corn Oil | 87.5 |
| 95.00% Corn Oil | 59.3 |
| 90.00% Corn Oil | 53.15 |
| 70.00% Corn Oil | 41.025 |
| 100.00% DHASCO ®-S | 36.2 |

TABLE 3

| Oil | OSI Value |
|---|---|
| 100.00% Soy Oil | 36.9 |
| 99.99% Soy Oil | 37.225 |
| 99.75% Soy Oil | 38.725 |
| 95.00% Soy Oil | 38.7 |
| 90.00% Soy Oil | 23.25 |
| 70.00% Soy Oil | 19.3 |
| 100.00% DHASCO ®-S | 36.2 |

TABLE 4

| Oil | OSI Value |
|---|---|
| 100.00% Canola Oil | 67.4 |
| 99.99% Canola Oil | 67.95 |
| 99.75% Canola Oil | 66.275 |
| 95.00% Canola Oil | 56.075 |
| 90.00% Canola Oil | 50.05 |
| 70.00% Canola Oil | 39.725 |
| 100.00% DHASCO ®-S | 36.2 |

TABLE 5

| Oil | OSI Value |
|---|---|
| 100.00% Safflower Oil | 28.5 |
| 99.99% Safflower Oil | 28.95 |
| 99.75% Safflower Oil | 29.75 |
| 95.00% Safflower Oil | 24.925 |
| 90.00% Safflower Oil | 22.8 |
| 70.00% Safflower Oil | 19.35 |
| 100.00% DHASCO ®-S | 36.2 |

TABLE 6

| Oil | OSI Value |
|---|---|
| 100.00% Sunflower Oil | 48.6 |
| 99.99% Sunflower Oil | 44.9 |
| 99.75% Sunflower Oil | 45.35 |
| 95.00% Sunflower Oil | 34.4 |
| 90.00% Sunflower Oil | 27.45 |
| 70.00% Sunflower Oil | 20.6 |
| 100.00% DHASCO ®-S | 36.2 |

The results show that an increase in the OSI induction period can be achieved with blends of DHASCO®-S and vegetable oils.

### Example 6

This example examines the sensory qualities of corn oil containing 0.5% w/w DHASCO®-S oil.

Sensory qualities of the blended oil composition were determined. The oil was then stored in a metal container at room temperature for six months and the sensory qualities of the oil were again determined. Characteristics were determined on a scale of 1-15, with 15 being the worst. Results are shown in Table 7.

TABLE 7
Sensory Results

| | Time | |
|---|---|---|
| Attributes | T = 0 | T = 6 months |
| AROMA | | |
| Total Impact | 3.5 | 4 |
| Green/Beany | 2.5 | 1.5 |
| Fishy | 0 | 0 |
| Painty | 0 | 2 |
| Herbal | 0 | 0 |
| Other | 1 | 2 |
| AROMATICS | | |
| Total Impact | 4.5 | 5.5 |
| Green/Beany | 1 | 1 |
| Fishy | 0 | 0 |
| Painty | 4 (painty/other)* | 4 (painty/other)* |
| Herbal | 0 | 0 |
| Other | | |
| Aftertaste | | painty |

*This is a characteristic of rancid corn oil, and is not related to DHA. This result indicates some inherent problem with the quality of the corn oil.

These results indicate that the sensory characteristic of oil blends of the present invention remain stable over storage times.

### Example 7

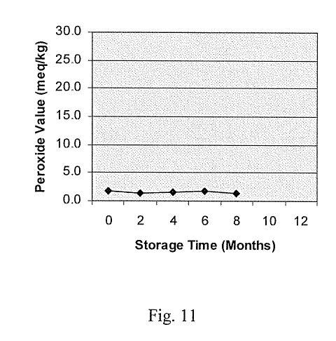

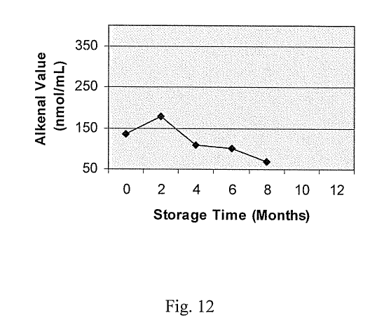

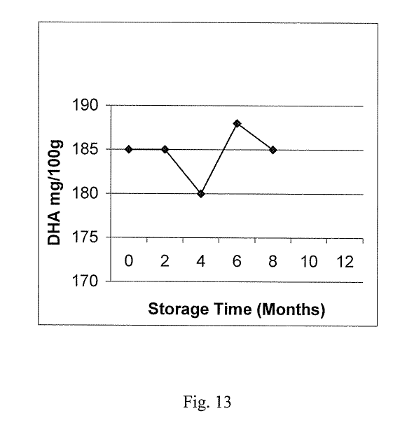

Corn oil containing 0.5% w/w DHASCO®-S oil from Example 6 was analyzed for peroxide content, alkenal content, and DHA level. Peroxide content is a measure of oxidation of the oil. Peroxide content is shown in FIG. 11. After eight months, there is no increase in the amount of peroxides in the oil. There is therefore no apparent oxidation of the oil. Alkenals are secondary products of oxidation. Alkenal content is shown in FIG. 12. There is no increase in the amount of alkenals in the oil, over time. Secondary products of oxidation typically increase as oxidation progresses or remain constant if there is no oxidation. DHA levels did not decrease over time, as shown in FIG. 13.

### Example 8

This example evaluates the use of corn oil containing 0.5% w/w DHASCO®-S oil from Example 6 that had been stored for six months to prepare French toast, French fries, and scrambled eggs.

Once the foods were cooked they were evaluated by a small taste panel. No off notes were detected in any of the foods.

Cooked foods were also evaluated for DHA content, to determine the amount of DHA transferred to the food from the oil. Samples of each food were freeze dried in preparation for analysis. Once dry, the samples were ground to a fine powder. DHA was determined by FAME analysis. Duplicate analyses were performed for each sample using a three-point internal standard (C23:0) calibration curve to quantitate DHA. The DHA results are summarized in Table 8. The eggs used to prepare the scrambled eggs naturally contained between 10 and 20 mg DHA per serving, and therefore the difference between 66.4 mg and the naturally occurring amount of 10-20 mg of DHA is due to DHA transfer from the fortified corn oil.

TABLE 8
DHA content of various foods cooked in DHA-fortified corn oil.

| | | | Fried Food DHA (mg |
|---|---|---|---|
| Sample | Solids | DHA (mg DHA Free | DHA Free Fatty |
| Description | (%) | Fatty Acids/g food)¹ | Acids/serving)² |
| French toast | 54.61 | 0.96 | 57.1 |
| French fries | 44.02 | 0.41 | 24.9 |
| Scrambled | 35.22 | 1.89 | 66.4 |
| eggs | | | |

¹Reported on a dry weight basis
²Reported on an “as received” basis

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the appended claims.

What is claimed is:

1. A topical food oil composition comprising a blend of a first oil comprising an LC PUFA, a second oil comprising substantially no LC PUFA, and that is liquid at room temperature, and an antioxidant, wherein the LC PUFA comprises between about 0.25% and about 10% of the food oil composition.

2. The composition of claim 1, wherein the LC PUFA comprises between about 1% and about 5% of the food oil composition.

3. The composition of claim 1, wherein the antioxidant is selected from the group consisting of vitamin E, butylhydroxytoluene (BHT), butylhydroxyanisole (BHA), tert-butylhydroquinone (TBHQ), propyl gallate (PG), vitamin C, phospholipids, and natural antioxidants, and combinations thereof.

4. The composition of claim 1, wherein the antioxidant comprises TBHQ.

5. The composition of claim 1, wherein the antioxidant is present in the oil blend in an amount of between about 0.01% and about 1%.

6. The composition of claim 1, wherein the antioxidant is present in the oil blend in an amount of between about 0.1% and about 0.5%.

7. The composition of claim 1, wherein the second oil is selected from the group consisting of borage oil, black currant seed oil, corn oil, coconut oil, canola oil, soybean oil, safflower oil, high oleic safflower oil, sunflower oil, high oleic sunflower oil, olive oil, evening primrose oil, cottonseed oil, rice bran oil, grapeseed oil, flaxseed oil, garlic oil, peanut oil, almond oil, walnut oil, wheat germ oil, sesame oil, animal fat, animal oil, marine fat, marine oil, microbial oil, a hydrogenated oil of any of the foregoing, and mixtures of the foregoing.

8. The composition of claim 1, wherein the LC PUFA is selected from the group consisting of an omega-3 LC PUFA, an omega-6 LC PUFA and mixtures thereof.

9. The composition of claim 8, wherein the LC PUFA is selected from the group consisting of docosahexaenoic acid, eicosapentaenoic acid, docosapentaenoic acid and arachidonic acid.

10. The composition of claim 1, wherein the first oil is from a microbial source.

11. The composition of claim 10, wherein the microbial source comprises a microorganism selected from the group consisting of algae, protists, bacteria and fungi.

12. The composition of claim 10, wherein the microbial source is an oleaginous microorganism.

13. The composition of claim 10, wherein the microbial source is a microorganism is selected from the group consisting of microorganisms of the genus Thraustochytrium, microorganisms of the genus Schizochytrium, microorganisms of the genus Althomia, microorganisms of the genus Aplanochytrium, microorganisms of the genus Japonochytrium, microorganisms of the genus Elina, microorganisms of the genus Crypthecodinium, microorganisms of the genus Mortierella and mixtures thereof.

14. The composition of claim 10, wherein the microbial source is a microorganism is selected from the group consisting of microorganisms of the genus Schizochytrium, microorganisms of the genus Crypthecodinium, microorganisms of the genus Mortierella and mixtures thereof.

15. The composition of claim 1, wherein the first oil is from a plant source.

16. The composition of claim 15, wherein the plant source has been genetically modified to produce long chain polyunsaturated fatty acids, wherein the plant is selected from the group consisting of soybean, corn, safflower, sunflower, canola, flax, peanut, mustard, rapeseed, chickpea, cotton, lentil, white clover, olive, palm, borage, evening primrose, linseed and tobacco.

17. The composition of claim 1, wherein the first oil is from an animal source.

18. The composition of claim 17, wherein the animal source is selected from the group consisting of aquatic animals, animal tissues and animal products.

19. The composition of claim 1, wherein the first oil comprises at least about 20% omega-3 LC PUFA, omega-6 LC PUFA or mixtures thereof.

20. The composition of claim 1, wherein the first oil contains at least about 60% omega-3 LC PUFA, omega-6 LC PUFA or mixtures thereof.

21. A food product comprising a composition according to claim 1.

22. A method of food preparation, comprising topically applying a composition according to claim 1 to a food product.

23. The method of claim 22, wherein the step of topically applying is selected from the group consisting of spraying, dipping and brushing.

24. The method of claim 22, further comprising packaging the food product comprising the composition according to claim 1.

25. The method of claim 24, wherein the step of packaging comprises packaging the food product in an inert atmosphere.

26. The method of claim 25, wherein the atmosphere comprises nitrogen.

27. The method of claim 26, wherein the atmosphere further comprises carbon dioxide.

28. The food oil composition of claim 1, wherein the second oil comprises an oil selected from the group consisting of corn oil, canola oil and soybean oil.

29. The food oil composition of claim 1, wherein the second oil comprises corn oil.
